(19) United States
(12) Patent Application Publication
(10) Pub. No.: US 2011/0191178 A1
(43) Pub. Date: Aug. 4, 2011

(54) SYSTEM AND METHOD FOR CONTEXTUAL ADVERTISING

(76) Inventors: Randall Delbert Newberg, Bozeman, MT (US); Tyler Michael Carneal, Bozeman, MT (US); Austen James Cameron, Bozeman, MT (US)

(21) Appl. No.: 12/699,712

(22) Filed: Feb. 3, 2010

(51) Int. Cl. G06Q 30/00; G06Q 50/00; H04N 5/91

(52) U.S. Cl. 705/14.53; 705/14.73

(57) ABSTRACT

System and method for contextual advertising in which a video file is encoded with cue points, and an XML file containing contextual advertisement information for at least three products is generated. When a first cue point is reached, the product image, product name and product description for the first contextual advertisement are encapsulated in a link to the product URL and displayed in a bottom panel. As each successive cue point is reached, the product image, product name and product description for each successive contextual advertisement are encapsulated in a link to the product URL for that contextual advertisement and displayed in the bottom panel, and the product image and product name for the contextual advertisement last appearing in the bottom panel are encapsulated in a link to the product URL and added to the side panel.

### BACKGROUND OF THE INVENTION

1. Field of the Invention

The present invention relates generally to the field of computer-implemented advertising, and more specifically, to a dynamically configured Flash video application for contextual advertising.

2. Description of the Related Art

Current methods of web-based advertising that are connected or related to streaming video content do not allow the site administrator, the content provider and/or the advertiser to define the advertisements that are to be associated with the video content being streamed. Most of this advertising is done via algorithms driven by the metadata attached to the video content or information specific to the consumer/user. As such, the advertisements associated with content are not contextual in terms of relating the specific video content to the products, services, or other commercial activities of the advertiser.

Existing web-based advertising models associated with video content allow the site administrator or the advertiser to make decisions about the content and type of advertising, but not which videos an advertisement appears in or when the advertisement appears. Currently, the video content provider is not able to customize the advertisement by defining the image, description of the advertised product/service, the title or caption of the advertisement, the associated link to where viewers will be taken upon clicking on the advertisement, the points in time within the video when advertisements will start and stop, or the duration for which the advertisement will be displayed to the viewer.

Web users primarily watch streaming web video content for purposes of being entertained or informed, and preferably without interruption. Existing advertising associated with web-based video content is obtrusive to the viewer's desire to be entertained or informed without interruption; that is, viewers are forced to watch advertisements before, during, or after the video content is playing(ed). Some current methods are obtrusive by laying ads over the video, which obscures the video while the user is watching it.

Existing web-based advertisements connected to streaming video content do not: (1) provide advertisements that are temporally related to the point in the video at which a given product or service is being demonstrated; and (2) retain the previously shown ads in other areas of the visual screen, allowing the viewer to investigate or act upon the advertisement at a later time during or after the video content is/has playing(ed). Existing advertising is either static in placement from beginning to end of the played content, or, if it is non-static, does not move to a location that allows the viewer to go back to the advertisement and view the advertisement at a later time.

### BRIEF SUMMARY OF THE INVENTION

The present invention is a system for contextual advertising comprising: a video file in which cue points have been encoded; and an XML file containing contextual advertisement information for at least three products; wherein each cue point corresponds to a given contextual advertisement; wherein the video file causes a video to be shown in a video display area with a bottom edge and a side edge; wherein the information for each contextual advertisement includes a product image, a product name, a product description and a product Uniform Resource Locator; wherein when a first cue point is reached in the video, the product image, product name and product description for the first contextual advertisement are encapsulated in a link to the product Uniform Resource Locator for the first contextual advertisement and displayed in a panel located outside of and along the bottom edge of the video display area; wherein when a second cue point is reached in the video, the product image, product name and product description for the second contextual advertisement are encapsulated in a link to the product Uniform Resource Locator for the second contextual advertisement and displayed in the bottom panel, and the product image and product name for the first contextual advertisement are encapsulated in a link to the product Uniform Resource Locator for the first contextual advertisement and displayed in a panel located outside of and along one of the side edges of the video display area; wherein when a third cue point is reached in the video, the product image, product name and product description for the third contextual advertisement are encapsulated in a link to the product Uniform Resource Locator for the third contextual advertisement and displayed in the bottom panel, and the product image and product name for the second contextual advertisement are encapsulated in a link to the product Uniform Resource Locator for the second contextual advertisement and displayed in the side panel along with the first contextual advertisement; and wherein as each successive cue point in the video is reached, the product image, product name and product description for each successive contextual advertisement are encapsulated in a link to the product Uniform Resource Locator for that contextual advertisement and displayed in the bottom panel, and the product image and product name for the contextual advertisement last appearing in the bottom panel are encapsulated in a link to the product Uniform Resource Locator for that contextual advertisement and added to the side panel along with contextual advertisements previously added to the side panel.

In a preferred embodiment, the video has content, and cue points are set in the video such that the content of the video at a given cue point relates to the product being advertised in the contextual advertisement corresponding to that cue point. Preferably, when a user seeks to a different point in the video, the invention applies a cueIndex rebuild algorithm to determine which contextual advertisement should appear in the bottom panel and which contextual advertisements should appear in the side panel.

In a preferred embodiment, video playback continues unstopped as contextual advertisements are displayed in the bottom and side panels. Preferably, if a user clicks on a link for any of the contextual advertisements displayed in the bottom or side panels, video playback is paused until the user returns to the video and clicks a play button.

The present invention is also a method for contextual advertising comprising: encoding a video file with cue points; and generating an XML file containing contextual advertisement information for at least three products; wherein each cue point corresponds to a given contextual advertisement; wherein the video file causes a video to be shown in a video display area with a bottom edge and a side edge; wherein the information for each contextual advertisement includes a product image, a product name, a product description and a product Uniform Resource Locator; wherein when a first cue point is reached in the video, the product image, product name and product description for the first contextual advertisement are encapsulated in a link to the product Uniform Resource Locator for the first contextual advertisement and displayed in a panel located outside of and along the bottom edge of the video display area; wherein when a second cue point is reached in the video, the product image, product name and product description for the second contextual advertisement are encapsulated in a link to the product Uniform Resource Locator for the second contextual advertisement and displayed in the bottom panel, and the product image and product name for the first contextual advertisement are encapsulated in a link to the product Uniform Resource Locator for the first contextual advertisement and displayed in a panel located outside of and along one of the side edges of the video display area; wherein when a third cue point is reached in the video, the product image, product name and product description for the third contextual advertisement are encapsulated in a link to the product Uniform Resource Locator for the third contextual advertisement and displayed in the bottom panel, and the product image and product name for the second contextual advertisement are encapsulated in a link to the product Uniform Resource Locator for the second contextual advertisement and displayed in the side panel along with the first contextual advertisement; and wherein as each successive cue point in the video is reached, the product image, product name and product description for each successive contextual advertisement are encapsulated in a link to the product Uniform Resource Locator for that contextual advertisement and displayed in the bottom panel, and the product image and product name for the contextual advertisement last appearing in the bottom panel are encapsulated in a link to the product Uniform Resource Locator for that contextual advertisement and added to the side panel along with contextual advertisements previously added to the side panel.

In a preferred embodiment, the video has content, and cue points are set in the video such that the content of the video at a given cue point relates to the product being advertised in the contextual advertisement corresponding to that cue point. Preferably, the invention further comprises applying a cueIndex rebuild algorithm to determine which contextual advertisement should appear in the bottom panel and which contextual advertisements should appear in the side panel when a user seeks to a different point in the video.

In a preferred embodiment, the invention further comprises continuing video playback unstopped as contextual advertisements are displayed in the bottom and side panels. Preferably, the invention further comprises, if a user clicks on a link for any of the contextual advertisements displayed in the bottom or side panels, pausing video playback until the user returns to the video and clicks a play button.

### BRIEF DESCRIPTION OF THE DRAWINGS

FIG. 1 is a flow chart of the process required to encode a Flash video file with cue points.

FIG. 2 is a flow chart of the process for creating an extensible markup language (XML) file containing contextual advertising information and formatted for use with the present invention.

FIG. 3 is a sample XML file containing contextual advertisement content formatted to be compatible with the present invention.

FIG. 4 is a first flow chart of the process required to invoke and initialize the present invention.

FIG. 5 is a second flow chart of the process required to invoke and initialize the present invention.

FIG. 6 is a graphical representation of the five arrays used in the present invention populated with sample data.

FIG. 7 is a flow chart of the run-time process of the present invention.

FIG. 8 is a flow chart depicting user interaction with the video player control bar and the associated cue point handling process.

FIG. 9 is a flow chart demonstrating a typical user's interaction with the contextual advertisements of the present invention.

FIG. 10 is a screenshot of the player of the present invention in a ready state.

FIG. 11 is a screenshot of the player of the present invention with the bottom panel in view and the video playing.

FIG. 12 is a screenshot of the player of the present invention with the bottom and side panels.

### DETAILED DESCRIPTION OF INVENTION

The present invention addresses the deficiencies in existing video advertisement models by providing advertisements that are contextually related to the content of the video and also by maintaining unobtrusive links (i.e., links that do not overlay or interrupt the content of the video) to all previously displayed ads so that the viewer can obtain information about the advertised products and/or services at any time during the video (without missing any part of the video) or after the video. The present invention is described in greater detail in reference to the figures, which are discussed below.

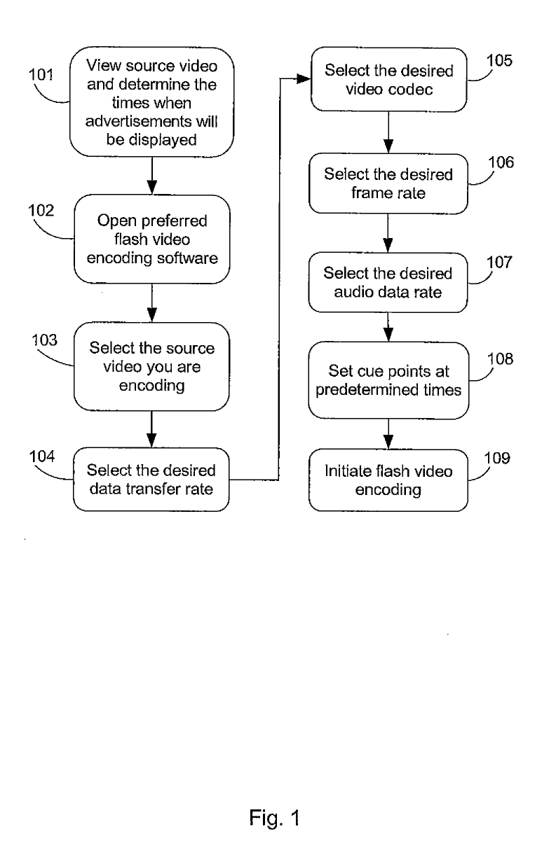

FIG. 1 is a flow chart of the process required to encode a Flash video file with cue points. Flash video (“FLV”) is preferred because of its progressive download capability and embedded meta information, such as cue points. Cue points are points in time within a video, and they are used in the present invention uses to trigger contextual advertisements. The first step in the process of encoding an FLV file with cue points is to watch the video and determine where (at what point) in the video the advertisements will be displayed 101. Once this step is completed, then the FLV encoding software is opened 102. One example of suitable FLV software is Adobe Flash Video Encoder CS3.

With the FLV encoding software opened, the source video that is to be encoded is selected 103. Next, the desired data transfer rate 104 and video codec 105 are selected 104. In a preferred embodiment, the data rate is set at 400 kilobytes per second, and the video codec is On2 VP6; however, the present invention is not limited to any particular data rate or video codec. Once the data rate and video codec have been selected, then the desired frame rate is selected 106. In a preferred embodiment, the frame rate is twenty-four (24) frames per second. Next, the audio data rate is selected 107. In a preferred embodiment, the audio data rate is 160 kilobytes per second stereo. The present invention is not limited to any particular frame rate or audio data rate.

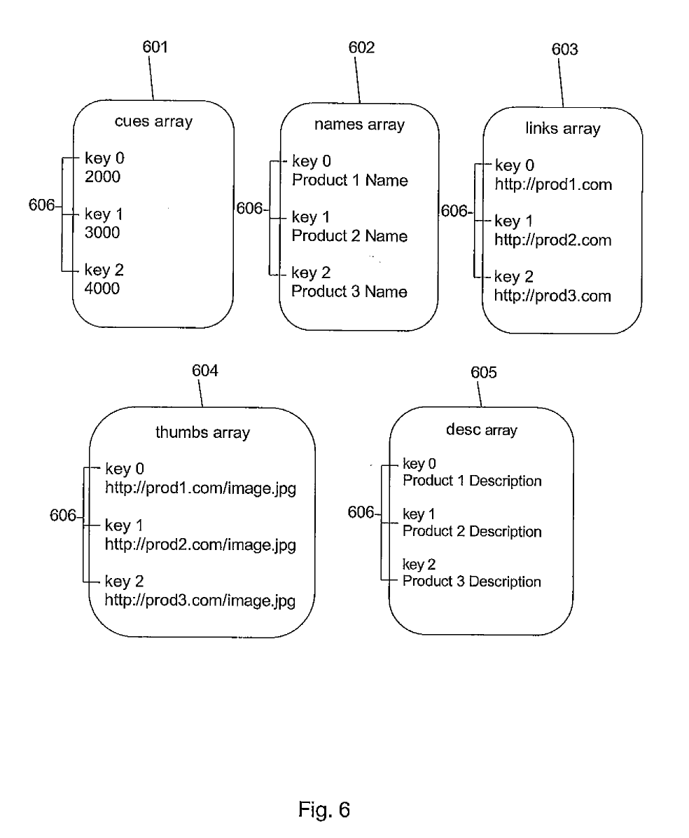

With the above-mentioned selections made, cue points are set at the time within the video that were determined at step 101. The method for setting cue points varies depending on the type of video encoding software used. With Adobe Flash Video Encoder CS3, cue points are added by selecting the Cue Points tab, selecting the plus icon, and specifying the time (in seconds or milliseconds) in the video at which the cue point will occur. This time value is the value that appears in the cues array (see FIG. 6) for each cue point and is referred to herein as the “cue point time.” Lastly, the FLV encoding is initiated 109.

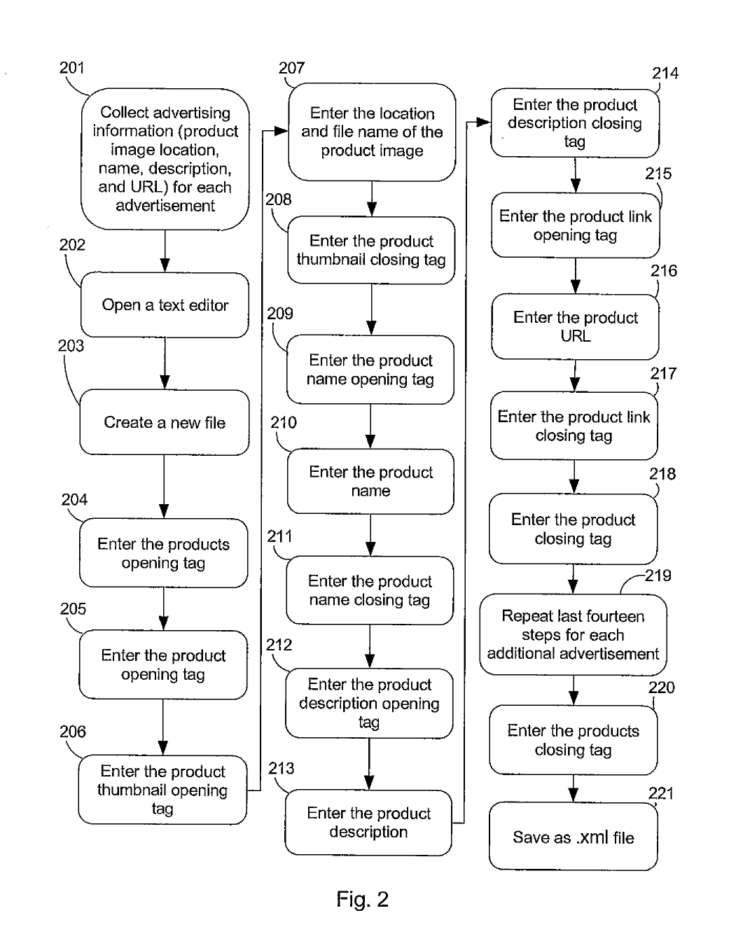

FIG. 2 is a flow chart of the process for creating an XML file containing contextual advertising information and formatted for use with the present invention. Each cue point that is set within the FLY file (see FIG. 1) has a corresponding entry in the XML file containing contextual advertising information. In the current embodiment, these entries are made manually by a programmer; however, these entries could be automated. In the present invention, there is a single XML file containing all of the contextual advertisement information for all of the cue points in the FLV. The first step in creating this XML file is to collect the following information for each contextual advertisement: product image location; product name; product description; and product Uniform Resource Locator (“URL”) 201. Next, a text editor is opened 202. One example of a suitable text editor is Notepad++, but the present invention is not limited to any particular text editor.

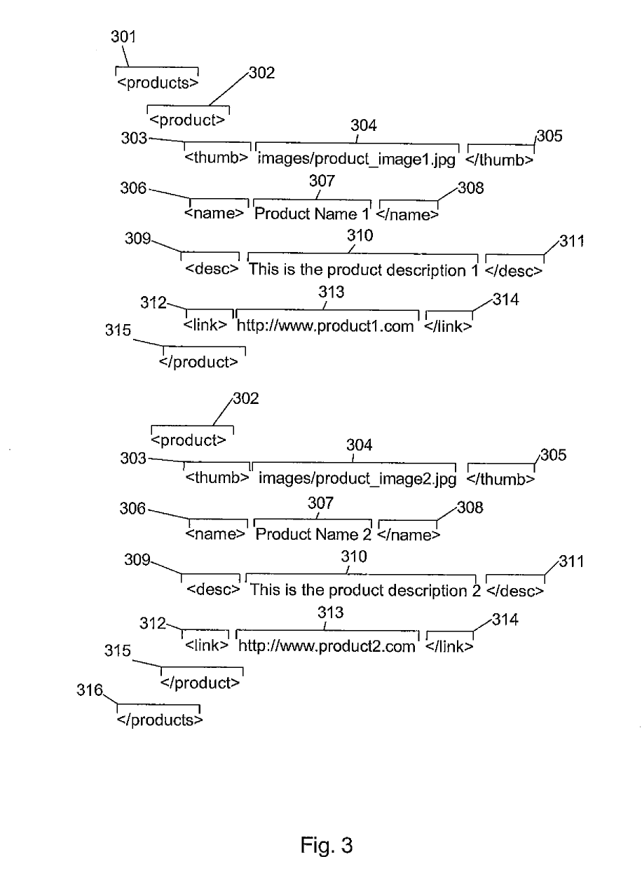

As required by the XML format, there is a tag hierarchy; for the present invention, that hierarchy enables the invention to pull in each contextual advertisement individually. The hierarchy is defined by opening and closing tags with other opening and closing tags nested in between them. An opening tag consists of a “<”, the name of the tag, and a “>”, whereas a closing tag consists of a “</”, the name of the tag, and a “>”. In the present invention, the hierarchy begins with the “products” opening and closing tags, which denote the beginning and end of a list of contextual advertisements. Next are the “product” opening and closing tags, which are nested between the “products” opening and closing tags; these “product” opening and closing tags denote one individual contextual advertisement. Nested between the product opening and closing tags are the thumb, name, desc, and link opening and closing tags. Nested between the opening and closing tags of thumb, name, desc, and link are the values for an individual contextual advertisement. These values define the content of each contextual advertisement. FIG. 3 illustrates the XML tag hierarchy of the present invention; in this example, only two contextual advertisements are shown.

With the text editor opened, a new file 203 is created, and the products opening tag 204 is entered. The products opening tag (reference number 301 in FIG. 3) denotes the beginning of a list of contextual advertisements. The next step is to enter the product opening tag 205. The product opening tag (reference number 302 in FIG. 3) denotes the beginning of one particular contextual advertisement. Next, the product thumbnail opening tag (reference number 303 in FIG. 3) is opened 206. The location and file name of the product image (reference number 304 in FIG. 3) are entered 207. Next, the product thumbnail closing tag (reference number 305 in FIG. 3) is entered 208, and the product name opening tag (reference number 306 in FIG. 3) is entered 209.

The product name (reference number 307 in FIG. 3) is entered 210, as is the product name closing tag (reference number 308 in FIG. 3) 211. Next, the product description opening tag (reference number 309 in FIG. 3) is entered 212, and the product description (reference number 310 in FIG. 3) is entered 213. Once the product description is entered, the product description closing tag (reference number 311 in FIG. 3) is entered 214. At this point, the product link opening tag (reference number 312 in FIG. 3) is entered 215, and the product URL (reference number 313 in FIG. 3) is entered 216. Lastly, the product link closing tag (reference number 314 in FIG. 3) and the product closing tag (reference number 315 in FIG. 3) are entered 217, 218. The product closing tag denotes the end of the contextual advertisement.

To add additional contextual advertisements 219, steps 205 through 218 are repeated for each advertisement. Once all advertisements corresponding to each cue point set in the FLV file 108 have been entered (i.e., steps 205 through 218 have been completed for each advertisement), then the products closing tag (see reference number 316 in FIG. 3) is entered 220, and the file is saved as a .xml file 221.

FIG. 3 is a sample XML file containing contextual advertisement content formatted to be compatible with the present invention. The file shown in FIG. 3 is an example of a file resulting from the steps outlined in FIG. 2. The XML file shown in FIG. 3 includes two contextual advertisements; however, the present invention is not limited to any particular number of contextual advertisements. The XML file of the present invention begins with a products tag 301, which indicates the beginning of a list of advertisements. Each individual advertisement is encapsulated between a product opening tag 302 and a product closing tag 315. In between these product opening and closing tags, each advertisement contains four elements: the product image 304, the product name 307, the product description 310, and the product URL 313. Each of the four elements is encapsulated by specific opening and closing tags, as shown in FIG. 3 and explained in connection with FIG. 2 above. The XML file ends with a products closing tag 316, which indicates the end of the file and the list of advertisements.

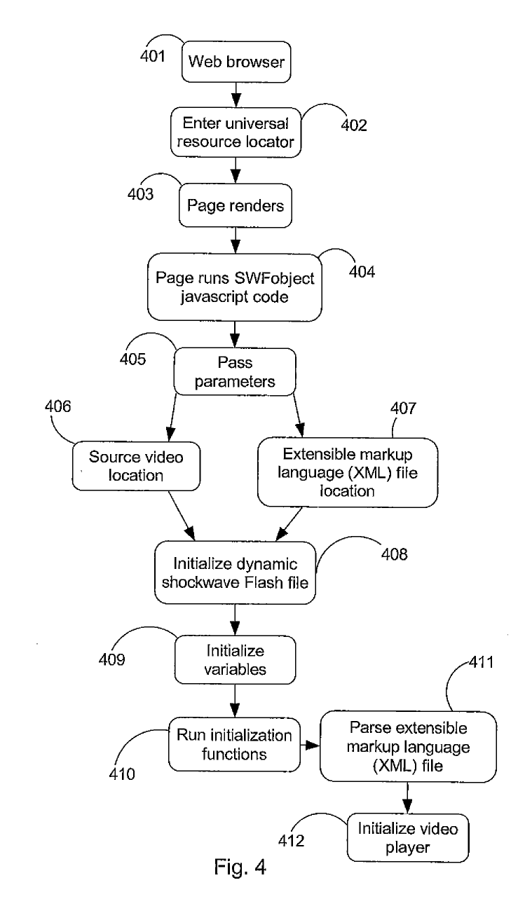

FIG. 4 is a flow chart of the process required to invoke and subsequently initialize the present invention, which is a dynamically configured Flash video application for contextual advertising. The user first enters a universal resource locator (URL) 402 into a web browser 401. This brings up a page that renders 403 within the web browser 101. When the page is rendered, a javascript file named SWFobject 404 is loaded and run by the web browser 401. SWFobject is the preferred Flash embedding methodology because of its ubiquity and cross-browser capabilities, though many viable alternative methodologies exist, one example of which is the direct object embed method. When SWFobject 404 is run, certain parameters are defined and passed 405 into the Flash application. These parameters are the source video location 406 and the extensible markup language (XML) file location 407.

The source video location 406 is either the relative or absolute location of the preconfigured FLV file (see FIG. 1). The XML file location 407 can be either the relative or absolute location of the pre-populated XML file discussed above in connection with FIGS. 2 and 3. This XML file contains the contextual advertising content, specifically, the product name 307, product description 310, product image location 304, and the URL to a web page where the product can be purchased 313. As used herein, the term “product” may mean a good, or it may mean a service; the present invention is not limited to any particular definition of the term “product.”

Once the web browser 401 initializes the Flash application 408 with the source video location 406 and the XML file location 407, the internal variables (set forth in Table 1 below by way of example) are initialized 409. When variables are initialized 409, the variable type (such as string or integer) is set, and a default value is assigned (the default values are set forth in Table 1). Next, the initialization functions are run 410. There are two primary initialization functions: the first function pulls content from the XML file location 407 and parses that content 411, and the second function initializes the video player 412.

TABLE 1

| Variable Name | Variable Type | Value | Description |
|---|---|---|---|
| BUFFER_TIME | Integer | 5 | Time to buffer for the |
| | | | video in seconds |
| DEFAULT_VOLUME | Integer | 0.6 | Set default volume |
| | | | level to 0.6 |
| DISPLAY_TIMER_UP | Integer | 100 | How often the |
| DATE_DELAY | | | progress bar times are |
| | | | updated |
| SMOOTHING | Boolean | TRUE | Bitmap smoothing on |
| | | | the video |
| BolLoaded | Boolean | FALSE | Tracks whether or not |
| | | | the FLV file has been |
| | | | loaded |
| BolVolumeScrub | Boolean | FALSE | Tracks user |
| | | | interaction with the |
| | | | volume bar |
| IntLastVolume | Integer | 0.6 | Sets the volume level |
| NcConnection | NetConnection | Null | Establishes a |
| | Object | | connection between |
| | | | the client and the |
| | | | server |
| NsStream | NetStream Object | Null | Used to send streams |
| | | | (data) through |
| | | | ncConnection |
| OnCuePoint | Event Handler | Null | Invoked when an |
| | | | embedded cue point |
| | | | is reached while |
| | | | playing an FLV file |
| ObjInfo | Object | Value pulled | Holds all the |
| | | from FLV file | metadata that is in the |
| | | | FLV file |
| shoVideoPlayerSettings | Shared Object | Local settings | Retains player |
| | | | settings on the client |
| | | | machine |
| StrSource | String | Null | Defines the source |
| | | | location of the FLV |
| | | | file |
| TmrDisplay | Timer | 100 | Creates display |
| | | | update timer |
| urlLoader | urlLoader | Null | Downloads data |
| UrlRequest | URLRequest | Null | Holds the data |
| | | | captured by the |
| | | | urlLoader |
| CuesXML | XML | Null | Holds cue point times |
| CueIndex | Integer | −1 | Reflects which |
| | | | contextual |
| | | | advertisement is |
| | | | currently showing in |
| | | | the bottom panel |
| TempIndex | Integer | −1 | Temporary variable |
| | | | for rebuilding |
| | | | cueIndex |
| Cues | Array | Null | Holds all of the cue |
| | | | point times |
| Names | Array | Null | Holds all of the name |
| | | | strings |
| Thumbs | Array | Null | Holds all of the |
| | | | thumbnail location |
| | | | strings |
| Links | Array | Null | Holds all of the link |
| | | | strings |
| Desc | Array | Null | Holds all of the |
| | | | description strings |
| BolSideOpen | Boolean | FALSE | Tracks whether side |
| | | | panel is open or |
| | | | closed |
| MouseClick | Boolean | FALSE | Records when there |
| | | | is a mouse click |

The contents of the XML file are parsed 411 by the invention and placed into arrays. The parsing function 411 pulls content from the XML file and reads through the content line-by-line. Custom tags corresponding to the products that are being advertised are defined within the XML document, as shown in FIG. 3. The invention recognizes the product opening tag 302 as the beginning of a new contextual advertisement and inserts the content into the associated arrays.

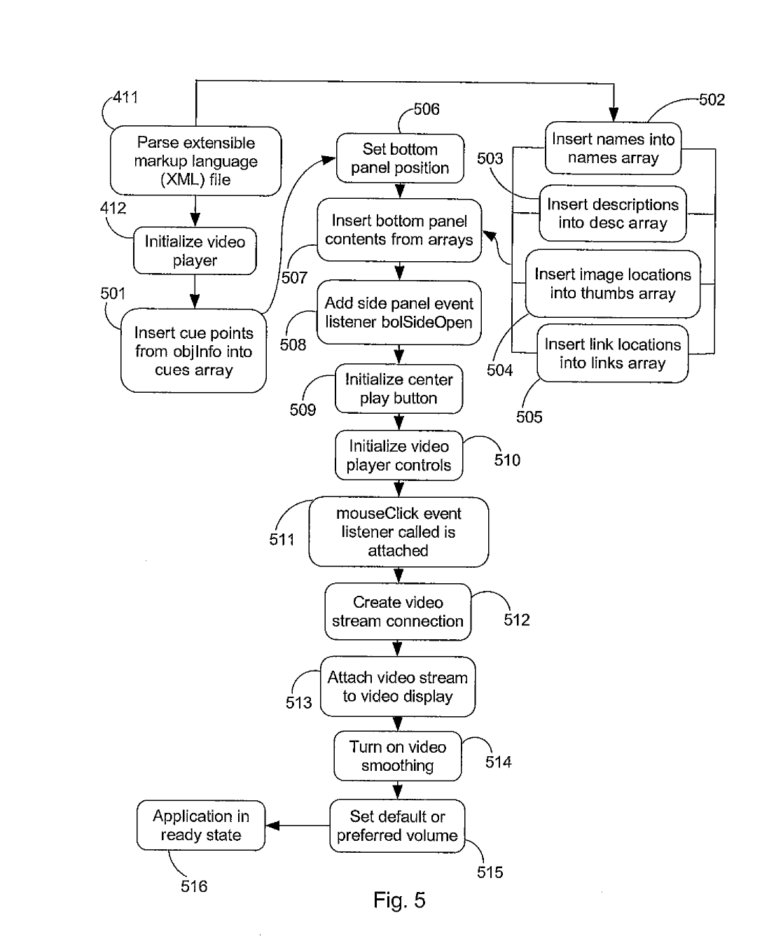

As noted above, each product tag contains four values: the product image location 304, product name 307, product description 310, and product URL 313 (see FIG. 3). When the XML file contents are parsed 411, each of these values is placed into a corresponding array as follows: the product image location 304 is inserted into the thumbs array 504; the product name 307 is inserted into the names array 502; the product description 310 is inserted into the desc array 503; and the product URL 313 is inserted into the links array 505 (see FIG. 5). This parsing is done for each individual contextual advertisement encapsulated between a product opening tag 302 and a product closing tag 315. All of the contextual advertisements are contained within a single XML file, as shown in FIG. 3, and encapsulated between the products opening tag 301 and the products closing tag 316. The invention recognizes the products opening tag 301 as the beginning of a list of one or more contextual advertisements, each of which is encapsulated between a product opening tag 302 and a product closing tag 315. The products closing tag 316 is recognized by the invention as the end of the list of contextual advertisements. In a preferred embodiment, the contextual advertisements are parsed in the order in which they appear in the list contained within the XML file (FIG. 3).

Once the parsing 411 is complete and the content has been inserted into the appropriate arrays, the video player is initialized 412. Initialization of the video player consists of setting up the visual elements, connecting the video stream to the player 513, and inserting the cue points embedded in the FLV file into the cues array 501 (see FIG. 5). The invention copies cue point times from the FLV file and saves them in the ObjInfo variable (see Table 1). The cue point times are then copied from the ObjInfo variable into the cues array 501 (shown in FIG. 6 as reference number 601). The bottom panel position is set 506 behind the video display 1002 so that it is not visible to the user. The contextual advertisement contents for the first advertisement are pulled from the arrays that were populated with the XML file content and placed into the bottom panel 507, readying the first contextual advertisement for the first cue point 703. The bolSideOpen event listener (see Table 1) is added 508; this event listener tracks whether the side panel is in view or not.

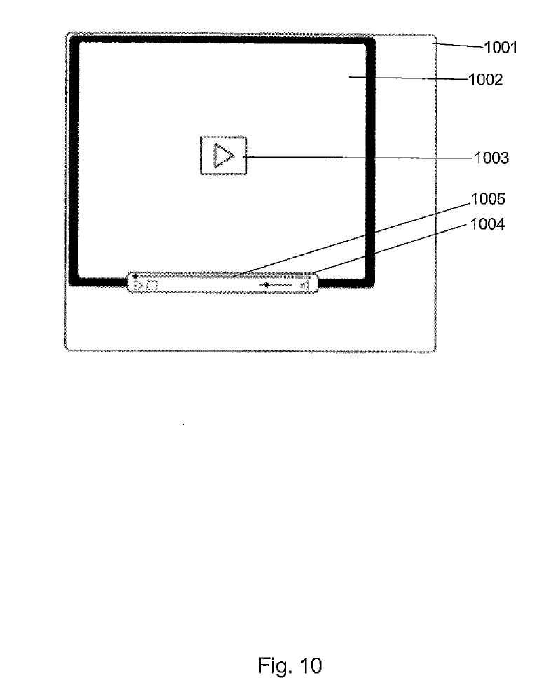

Once the center play button is initialized 509, the triangular play button 1003 is added over the center of the video display 1002 (see FIG. 10). Next, video player controls are initialized 510, adding the player controls 1004 below the video display 1002; these controls are preferably invisible to the user until the video is played. The mouse click event listener (called mouseClick in Table 1) is attached 511 to the video display 1002; this event listener enables the click-to-play functionality of the center play button 1003 added earlier 509. Next, the video stream connection is created 512, and the video is attached to the video display 513. Video smoothing is enabled 514; the video smoothing functionality is a built-in Flash function that interpolates scaled video to improve the perceived quality. The volume is set 515 to the default value specified in Table 1 or to a preferred value that is set by the user and stored in a Flash cookie on the user's machine. The application is now in the ready state 516, the player is ready to stream video, and the first contextual advertisement is in the bottom panel out of view for when video playback reaches the first cue point 703.

FIG. 6 is a graphical representation of the five arrays used in the present invention populated with sample data. In a preferred embodiment, each array is keyed 606, which means that a key in the cues array 601 contains data related to the same key number in the names array 602, links array 603, thumbs array 604, and desc array 605. For example, the key 0 data in the cues array contains each of the four elements (product name, product URL, product image and product description) for a first contextual advertisement (typically, the first contextual advertisement to appear in the video). In FIG. 6, keys 1 and 2 represent the second and third contextual advertisements. The present invention is not limited to any particular number of advertisements; three advertisements (represented by keys 0, 1 and 2) are shown in FIG. 6 for simplicity. The values shown in the cues array 601 are the cue point times (shown here in milliseconds) for each contextual advertisement.

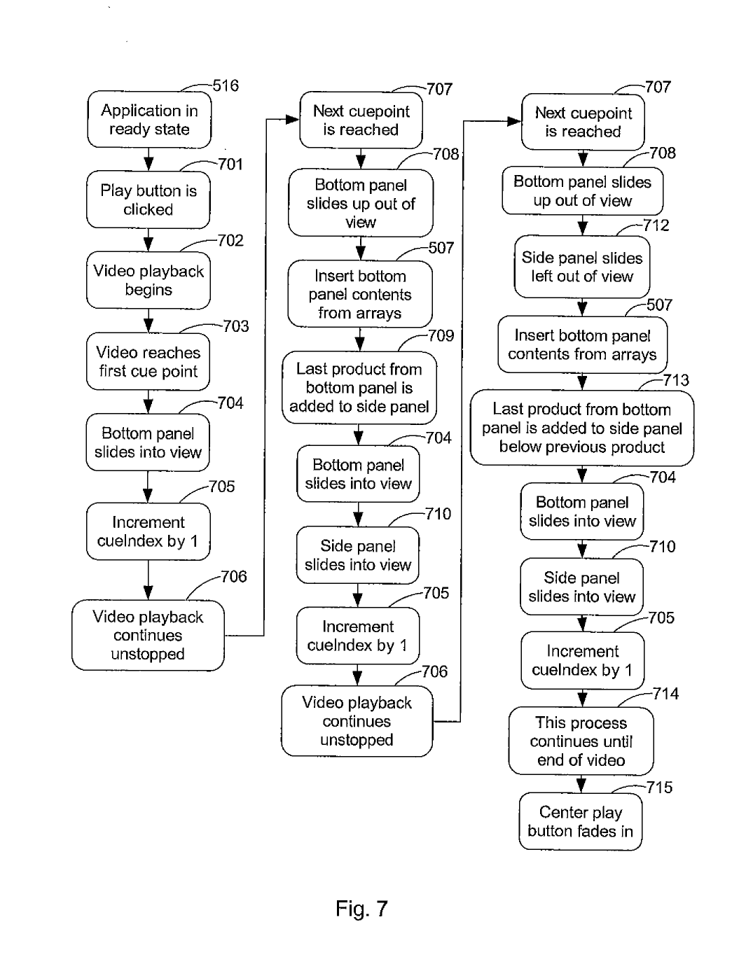

FIG. 7 is flow chart illustrating the run-time process. The application is in the ready state 516. To play the video, the user clicks the play button 1003 (see FIG. 10). Initially, both the bottom panel and side panel are not visible to the user (as shown in FIG. 10). The clicking of the play button by the user 701 is recognized by the mouseClick event listener described above, and video playback begins 702. The video plays and reaches the first cue point 703 that was set in the FLY file 108. The variable NsStream, which is a netStream object (see Table 1), has an associated built-in Flash event handler called on CuePoint (see Table 1). The on CuePoint event handler recognizes when a cue point is reached during the playback of an FLV file containing embedded cue points. In a preferred embodiment, the present invention utilizes the on CuePoint event handler to recognize cue points.

When the invention reaches a cue point, it calls a custom function named cueHandler, which looks up the cueInclex variable (see Table 1) and uses that value to determine what to do next. If the value is equal to negative one, which is the value to which it is initially set, then the system knows that there are no contextual advertisements in view, and the previously hidden bottom panel slides down into view 704, thereby exposing the first contextual advertisement. The bottom panel preferably contains a contextual advertisement related to something that is being used or portrayed in the video. The cueIndex variable is then incremented by one 705, setting it to zero, and video playback continues unstopped 706.

Video playback continues 706 until the second cue point is reached 707. At this point, the present invention checks the cueIndex and bolSideOpen variables (Table 1) to determine what action to take. The bolSideOpen variable is a boolean type variable, which means that it can only have two values: true or false. The purpose of the bolSideOpen variable is to track whether the side panel is showing (true) or not showing (false); this variable is initially set to false. If the bolSideOpen variable is false, then the bottom panel slides up and out of view 708, the side panel is opened with the product name, product URL and product image for the first contextual advertisement (corresponding to the first cue point) displayed in the side panel, and the contextual advertisement information (product name, product URL and product image) for the second contextual advertisement (corresponding to the second cue point) is displayed in the bottom panel. The bottom panel contents are set from the arrays according to the eueIndex variable (Table 1) value. For example, if the cueIndex variable is equal to 0, then the present invention will pull the information from each array at key 1 for the bottom panel; if the cueIndex variable is equal to 1, then the present invention will pull the information from each array at key 2 for the bottom panel; and so on.

When the third cue point is reached in the video, the product name, product URL and product image location from the bottom panel (at this point, for the second contextual advertisement) are added to the side panel 709. The bottom panel then slides into view 704 with the contextual advertisement for the third cue point, and the side panel slides into view 710 with the product image and product name encapsulated in a link pointed to the product URL of the last (i.e., second) bottom panel advertisement. In a preferred embodiment, the information corresponding to the second advertisement is added to the side panel along with the information corresponding to the first advertisement; in this manner, the advertisements shown in the side panel are cumulative and one does not replace another. (There is preferably no limit to the number of ads that are included in the side panel; in a preferred embodiment, a scroll bar appears if there are more ads than can be displayed at one time.) The cueIndex variable is incremented by one 705 so that it now corresponds to the key number for the contextual advertisement appearing in the bottom panel (for example, the cueIndex variable would be set to 2 when the third contextual advertisement appears in the bottom panel). The video playback continues unstopped throughout this whole process 706.

When the next cue point is reached, the entire process described above repeats itself, and the last product from the bottom panel is added to the side panel below the previous product 713. In this manner, all of the contextual advertisements shown throughout the video are available to the user at any time in either the bottom or side panel (but never both at the same time). This process continues until the video ends 714 and the center play button fades in 715, thereby providing the user the option to replay the video if desired.

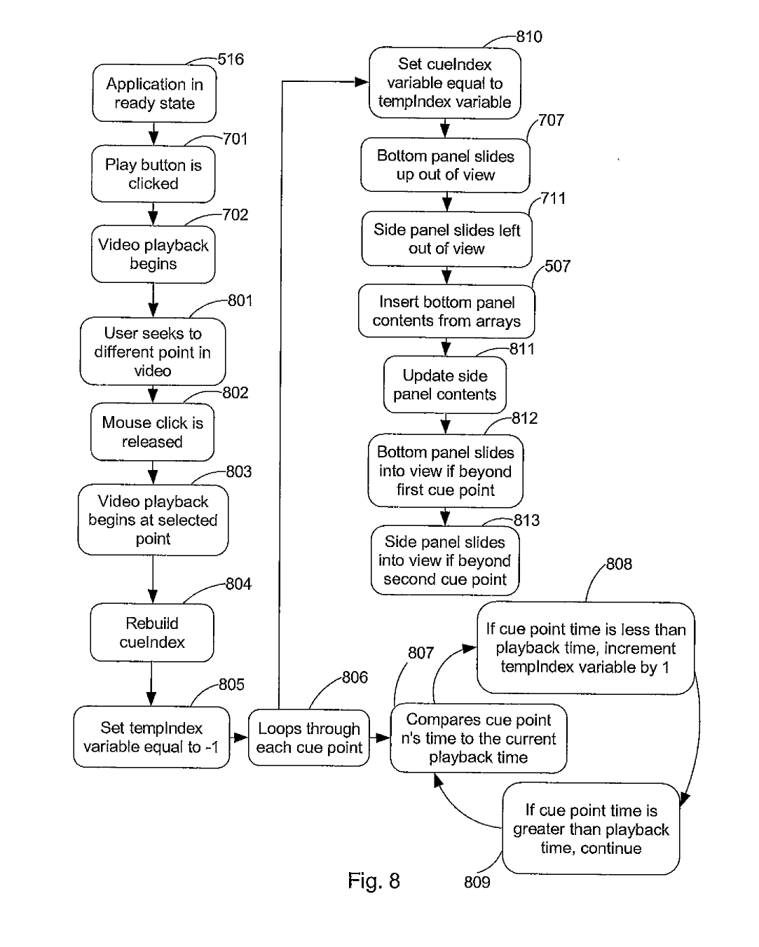

FIG. 8 is a flow chart depicting user interaction with the video player control bar and the associated cue point handling process. The user clicks the play button 701, which is recognized by the mouseClick event listener (Table 1), and video playback begins 702. At this point or any point during video playback, the user can seek to a different point in the video 801 via the video progress bar 1005 on the video player control bar 1004 (see FIG. 10). When the user releases the mouse button 802, video playback begins at the selected point 803, and the function to rebuild the cueIndex is called 804.

The cueIndex rebuild algorithm compares the current playback time to each cue point time in the cues array 601 in a loop 806, which means the algorithm makes the aforementioned comparison repeatedly (beginning at key 0 of the cues array) until each cue point in the cues array has been compared to the current playback time. The cueIndex variable is set to the appropriate value after the algorithm has looped through each cue point.

The algorithm begins by setting the tempIndex variable equal to negative one 805. The loop then starts 806 by comparing the playback time selected by the user 801 to the cue point time for the first cue point 807. The first cue point is defined by the first key of the cues array 601, which is represented by key 0 in FIG. 6. The cue points in the cues array are listed in the order in which they appear in the video. If the cue point time is less than the playback time, then the tempIndex variable is incremented by one 808 for each cue point for which the cue point time is less than the playback time. If the cue point time is greater than the playback time, then the loop continues 809 without incrementing the tempIndex variable. The algorithm continues until it has looped through all the cue points (key values) in the cues array 601. Once all of the cue points in the cues array have been compared to the current playback time and the tempIndex variable has been incremented (or not incremented) accordingly, the cueIndex variable is set equal to the tempIndex variable 810.

Once the cueIndex variable has been reset, the bottom panel slides up out of view 707, and the side panel slides left out of view 711. Based upon the value of the rebuilt cueIndex variable (see steps 804 through 809 in FIG. 8), the bottom panel contents are set from the arrays 507 using the cueIndex variable to determine the correct array key from which to pull content. Simultaneously, the side panel contents are updated with the contextual advertisements that would have been shown at this point in the video 811 based upon the value of the rebuilt cueIndex variable. If the number of contextual advertisements in the side panel exceeds the amount of room in the panel, a scroll bar is added to the right side of the panel, allowing for any number of contextual advertisements to be included in the side panel. The bottom panel slides into view if the playback time is beyond the first cue point 812, and the side panel slides into view if the playback time is beyond the second cue point or key 1 in the cues array 813. This process ensures that the contextual ads displayed are in sync with the point in time in the video being played when the user seeks back or forward in the video using the video progress bar 1005 (which also functions as a video seek bar) on the video player control bar 1004.

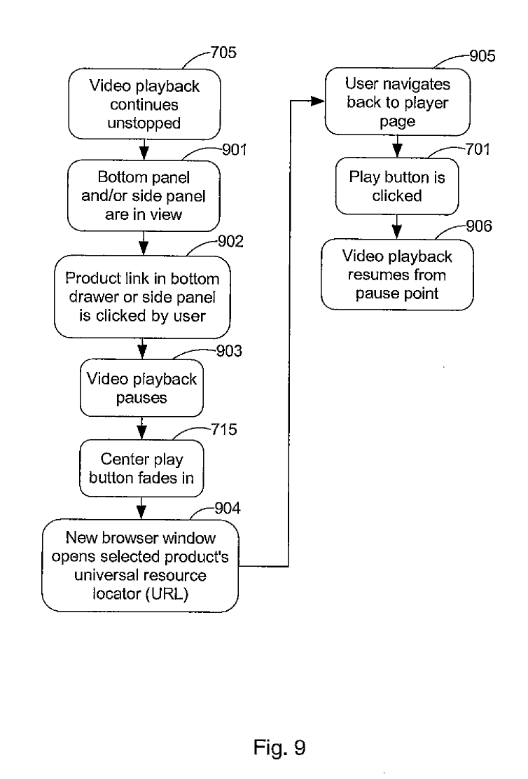

FIG. 9 is a flow chart demonstrating a typical user's interaction with the contextual advertisements and the player and browser reactions. As the video plays back 705 and the bottom panel, side panel, or both are in view 901, the user selects a product by clicking on the bottom panel anywhere (the whole panel is the product URL link) or by clicking on one of the advertisements in the side panel (each advertisement is a product URL link) 902. Video playback pauses 903, and the center play button fades in 715.

A new browser window is opened with the URL for the selected product 904. The user can then take action on the page to which he was directed, and, when finished, navigate back to the page of the present invention with the player paused 905 at the point at which the video was when the user clicked the contextual advertisement 902 (i.e., the bottom panel or an advertisement in the side panel). The user can then click the play button 1003, and video playback resumes from the point at which video playback was paused 906.

FIG. 10 is a screenshot of the player in the ready state 516 within the previously rendered page 403. The video stream is attached to the display 1002, the center play button 1003 is initialized, and the video player controls 1004 (which include the video progress bar 1005) are initialized.

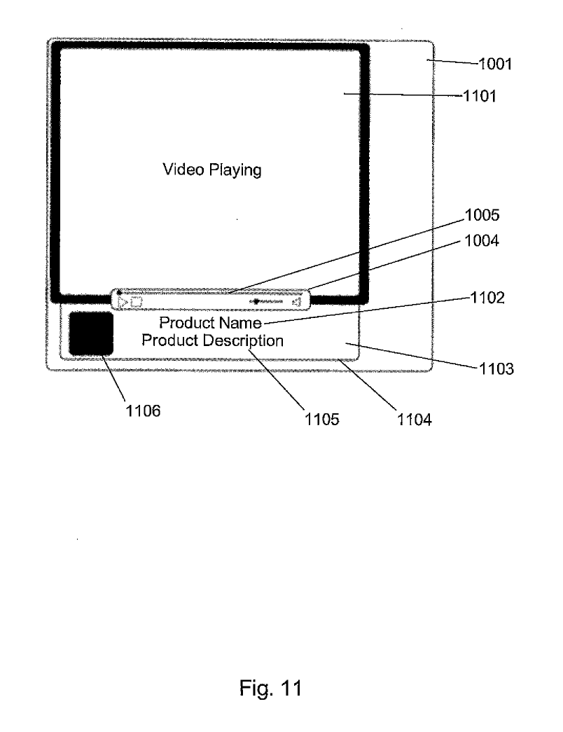

FIG. 11 is a screenshot of the player with bottom panel 1104 in view and the video 1101 playing. The bottom panel is populated with the contextual advertisement elements: product name 1102, product description 1105, product image 1106, and product URL 1103, which is a link to a web page that advertises the product. In a preferred embodiment, this link covers the entire bottom panel 1104 and its contents. The contextual advertisement displayed in the bottom panel is dependent on the current playback time and associated cue points. All of the data that is feeding the contextual advertisements is populated from the parsing 411 of the one XML file (see FIG. 3) containing all of the contextual advertisements.

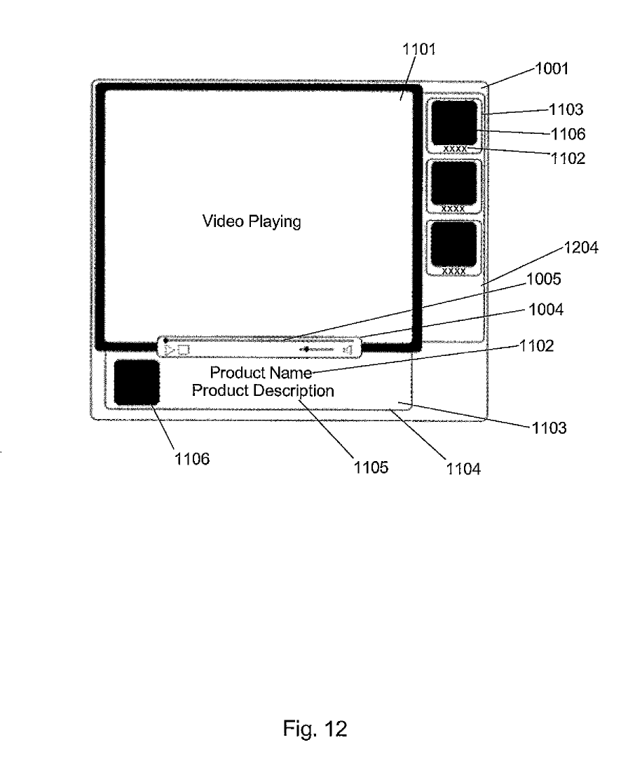

FIG. 12 is a screenshot of the player with both the bottom panel 1104 and side panel 1204 in view. The player state portrayed indicates that four cue points have been reached in the video. One contextual advertisement is shown in the bottom panel, and three prior contextual advertisements (i.e., contextual advertisements whose cue points were earlier in the video than the advertisement shown in the bottom panel) are shown in the side panel. The three products in the side panel are contextual advertisements that were previously shown in the bottom panel and added to the side panel when a new cue point was reached 412.

Each product in the side panel consists of three elements: the product name 1102, product image 1106, and product URL 1103. The product name 1102 and product image 1106 are encapsulated in a link to the product URL 1103. The side panel consists of one or more contextual advertisements, each advertisement representing a different product, and each advertisement comprising a different product name 1102 and product image 1106. Each contextual advertisement in the side panel is associated with a cue point that has already been passed in the video. In addition, each product displayed in the side panel has already been displayed in the bottom panel.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A system for contextual advertising comprising:
(a) a video file in which cue points have been encoded; and
(b) an XML file containing contextual advertisement information for at least three products;
wherein each cue point corresponds to a given contextual advertisement;
wherein the video file causes a video to be shown in a video display area with a bottom edge and a side edge;
wherein the information for each contextual advertisement includes a product image, a product name, a product description and a product Uniform Resource Locator;
wherein when a first cue point is reached in the video, the product image, product name and product description for the first contextual advertisement are encapsulated in a link to the product Uniform Resource Locator for the first contextual advertisement and displayed in a panel located outside of and along the bottom edge of the video display area;
wherein when a second cue point is reached in the video, the product image, product name and product description for the second contextual advertisement are encapsulated in a link to the product Uniform Resource Locator for the second contextual advertisement and displayed in the bottom panel, and the product image and product name for the first contextual advertisement are encapsulated in a link to the product Uniform Resource Locator for the first contextual advertisement and displayed in a panel located outside of and along one of the side edges of the video display area;
wherein when a third cue point is reached in the video, the product image, product name and product description for the third contextual advertisement are encapsulated in a link to the product Uniform Resource Locator for the third contextual advertisement and displayed in the bottom panel, and the product image and product name for the second contextual advertisement are encapsulated in a link to the product Uniform Resource Locator for the second contextual advertisement and displayed in the side panel along with the first contextual advertisement; and
wherein as each successive cue point in the video is reached, the product image, product name and product description for each successive contextual advertisement are encapsulated in a link to the product Uniform Resource Locator for that contextual advertisement and displayed in the bottom panel, and the product image and product name for the contextual advertisement last appearing in the bottom panel are encapsulated in a link to the product Uniform Resource Locator for that contextual advertisement and added to the side panel along with contextual advertisements previously added to the side panel.

2. The system of claim 1, wherein the video has content, and cue points are set in the video such that the content of the video at a given cue point relates to the product being advertised in the contextual advertisement corresponding to that cue point.

3. The system of claim 1, wherein when a user seeks to a different point in the video, the invention applies a cueIndex rebuild algorithm to determine which contextual advertisement should appear in the bottom panel and which contextual advertisements should appear in the side panel.

4. The system of claim 1, wherein video playback continues unstopped as contextual advertisements are displayed in the bottom and side panels.

5. The system of claim 1, wherein if a user clicks on a link for any of the contextual advertisements displayed in the bottom or side panels, video playback is paused until the user returns to the video and clicks a play button.

6. A method for contextual advertising comprising:
(a) encoding a video file with cue points; and
(b) generating an XML file containing contextual advertisement information for at least three products;
wherein each cue point corresponds to a given contextual advertisement;
wherein the video file causes a video to be shown in a video display area with a bottom edge and a side edge;
wherein the information for each contextual advertisement includes a product image, a product name, a product description and a product Uniform Resource Locator;
wherein when a first cue point is reached in the video, the product image, product name and product description for the first contextual advertisement are encapsulated in a link to the product Uniform Resource Locator for the first contextual advertisement and displayed in a panel located outside of and along the bottom edge of the video display area;
wherein when a second cue point is reached in the video, the product image, product name and product description for the second contextual advertisement are encapsulated in a link to the product Uniform Resource Locator for the second contextual advertisement and displayed in the bottom panel, and the product image and product name for the first contextual advertisement are encapsulated in a link to the product Uniform Resource Locator for the first contextual advertisement and displayed in a panel located outside of and along one of the side edges of the video display area;
wherein when a third cue point is reached in the video, the product image, product name and product description for the third contextual advertisement are encapsulated in a link to the product Uniform Resource Locator for the third contextual advertisement and displayed in the bottom panel, and the product image and product name for the second contextual advertisement are encapsulated in a link to the product Uniform Resource Locator for the second contextual advertisement and displayed in the side panel along with the first contextual advertisement; and
wherein as each successive cue point in the video is reached, the product image, product name and product description for each successive contextual advertisement are encapsulated in a link to the product Uniform Resource Locator for that contextual advertisement and displayed in the bottom panel, and the product image and product name for the contextual advertisement last appearing in the bottom panel are encapsulated in a link to the product Uniform Resource Locator for that contextual advertisement and added to the side panel along with contextual advertisements previously added to the side panel.

7. The method of claim 6, wherein the video has content, and cue points are set in the video such that the content of the video at a given cue point relates to the product being advertised in the contextual advertisement corresponding to that cue point.

8. The method of claim 6, further comprising applying a cueIndex rebuild algorithm to determine which contextual advertisement should appear in the bottom panel and which contextual advertisements should appear in the side panel when a user seeks to a different point in the video.

9. The method of claim 6, further comprising continuing video playback unstopped as contextual advertisements are displayed in the bottom and side panels.

10. The method of claim 6, further comprising, if a user clicks on a link for any of the contextual advertisements displayed in the bottom or side panels, pausing video playback until the user returns to the video and clicks a play button.
